(19) United States
(12) Patent Application Publication
(10) Pub. No.: US 2016/0038789 A1
(43) Pub. Date: Feb. 11, 2016

(54) COVERT CLIMBER TELESCOPING LADDER

(71) Applicant: Jay Patrick Cheyne, Brighton, MI (US)

(72) Inventor: Jay Patrick Cheyne, Brighton, MI (US)

(21) Appl. No.: 14/455,488

(22) Filed: Aug. 8, 2014

(51) Int. Cl. A63B 27/00; A62B 35/00

(52) U.S. Cl. CPC A63B 27/00; A62B 35/0081

(57) ABSTRACT

A tube-within-a-tube single pole extendable ladder has individual rungs that fold up into the body for portability and minimum bulkiness for transportation. In an exemplary embodiment, the climbing device can be used by hunters. The climbing device has a slender design that is easy to carry through dense underbrush. It is diminutive in appearance while in use. Once mounted to a tree, the main unit can be removed from its harness and transported to another location for use with another harness or removed for security purposes. The telescoping ladder can then be reattached to the tree or other structure simply by mounting to the harness with no tools and retained by a latching component. With the use of a carrying strap, the entire unit, in its closed state, can be transported to the next location and snapped into the provided harness, and is ready to climb.

### BACKGROUND OF THE INVENTION

The present invention relates to ladders and, more particularly, to a height adjustable telescoping ladder pole with attached fold-in steps, stabilizer bars and base support.

Existing means of mobile expanding climbing devices follow a typical ladder style (two pole and rungs) which makes for bulkiness during manual transport. These devices are typically of large width and length which poses challenges for carrying and erecting.

With conventional devices, the entire ladder must be disassembled in sections for transport to the next location of erection. Moreover, with conventional devices, the assembly takes place on the ground and the unit is then tilt-raised over head, which can be cumbersome and dangerous. The operator then leans the ladder against the structure and must dangerously climb the unsecured ladder in order to secure the top to the structure. There is also a danger due to the operator's motion on the ladder, which can cause the top to move and the ladder and operator to fall.

As can be seen, there is a need for an improved ladder that allows a climber to safely and easily reach extended heights.

### SUMMARY OF THE INVENTION

In one aspect of the present invention, a climbing device comprising: an outer body; a sliding body telescopically disposed in the outer body and extendable therefrom; a plurality of foldable foot assemblies operable to pivot outwardly from the climbing device; and a harness operable to attach to a structure, the harness operable to removably secure the outer body.

In another aspect of the present invention, a climbing device comprises: an outer body; a sliding body telescopically disposed in the outer body and extendable therefrom; a locking body assembly configured to lock the sliding body in a fixed position relative to the main outer body; a harness having upper and lower harness brackets operable to attach to a structure, the harness operable to removably secure the outer body; and a plurality of foldable foot assemblies operable to pivot outwardly from each of the outer body and the sliding body.

These and other features, aspects and advantages of the present invention will become better understood with reference to the following drawings, description and claims.

### BRIEF DESCRIPTION OF THE DRAWINGS

FIG. 1A is a perspective view of a telescoping ladder according to an exemplary embodiment of the present invention;

FIG. 1B is a detailed perspective view of an upper and lower end of the telescoping ladder of FIG. 1A;

FIG. 2A is a top view of the main outer body of FIG. 1A;

FIG. 2B is a bottom view of the main outer body of FIG. 1A;

FIG. 2C is a detail view of an upper end of the main outer body of FIG. 2A;

FIG. 2D is a detail view of a lower end of the main outer body of FIG. 2A;

FIG. 2E is a detail perspective view of a rotation lock within the main outer body of FIG. 2A;

FIG. 3A is a detail perspective view of the foldable foot assembly of the main outer body of FIG. 2A;

FIG. 3B is a detail perspective view of the foldable foot assembly of the main outer body of FIG. 2A;

FIG. 4A is a detail perspective view of the locking body assembly of the main outer body of FIG. 2A;

FIG. 4B is a detail perspective view of the locking body assembly of the main outer body of FIG. 2A;

FIG. 5A is a perspective view of the sliding body of the telescoping ladder of FIG. 1A;

FIG. 5B is a detail perspective view of an upper end of the sliding body of FIG. 5A;

FIG. 5C is a detail perspective view of a lower end of the sliding body of FIG. 5A;

FIG. 6A is a detail perspective view of the foldable foot assembly of the sliding body of FIG. 5A;

FIG. 6B is a detail perspective view of the foldable foot assembly of the sliding body of FIG. 5A;

FIG. 7 is a perspective view of the harness and a detail perspective view of the brackets of the present invention;

FIG. 8A is a perspective view of the carrying strap of the present invention;

FIG. 8B is a detail view of a spring snap of the carrying strap of FIG. 8B;

FIG. 9A is front view of the telescoping ladder of FIG. 1A attached to an exemplary tree;

FIG. 9B is a side view of the telescoping ladder of FIG. 1A attached to an exemplary tree;

FIG. 10 is a detail top view of the locking mechanism of the main outer body of FIG. 2A;

FIG. 11 is a side view of the locking mechanism detached from the upper mounting bracket;

FIG. 12 is a side view of the telescoping ladder with the sliding body extending from the main outer body;

FIG. 13A is a perspective view of the telescoping ladder with the sliding body extending from the main outer body;

FIG. 13B is a detail perspective view of the foldable foot assembly of the main outer body of FIG. 13A; and

FIG. 13C is a detail perspective view of the foldable foot assembly of the sliding body of FIG. 13A.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a mobile expanding climbing device designed as a tube-within-a-tube single pole extendable ladder with individual rungs that fold up into the body for portability and minimum bulkiness for transportation. When fully collapsed and closed for transportation, the unit is a slender pole for ease of carrying. In an exemplary embodiment, the climbing device can be used by hunters. The climbing device has a slender design that is easy to carry through dense underbrush. It is diminutive in appearance while in use as opposed to larger ladders. Once mounted to a tree, the main unit can be removed from its harness and transported to another location for use with another harness or removed for security purposes. The telescoping ladder can then be reattached to the tree or other structure simply by mounting to the harness with no tools and retained by a latching component. With the use of a carrying strap, the entire unit, in its closed state, can be transported to the next location and snapped into the provided harness, and is ready to climb.

With the telescoping ladder of the present invention, the main straps of the harness are at the foot and head levels of the operator. If a second strap is required at the top of the unit, the operator can climb to that point and restrain the unit to the structure while the unit is safely attached to the tree.

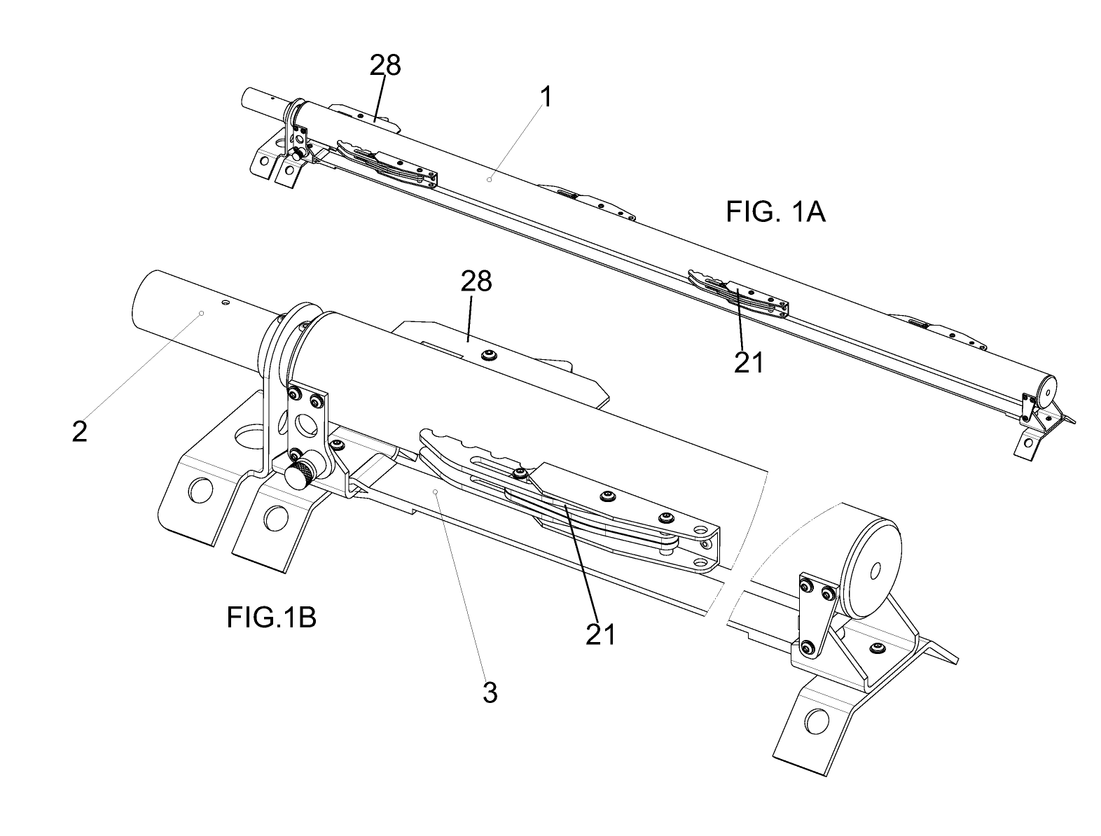

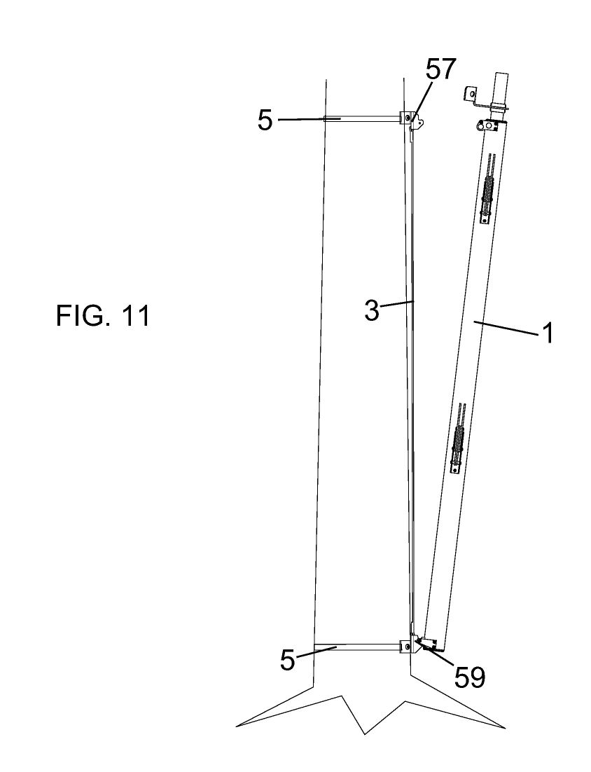

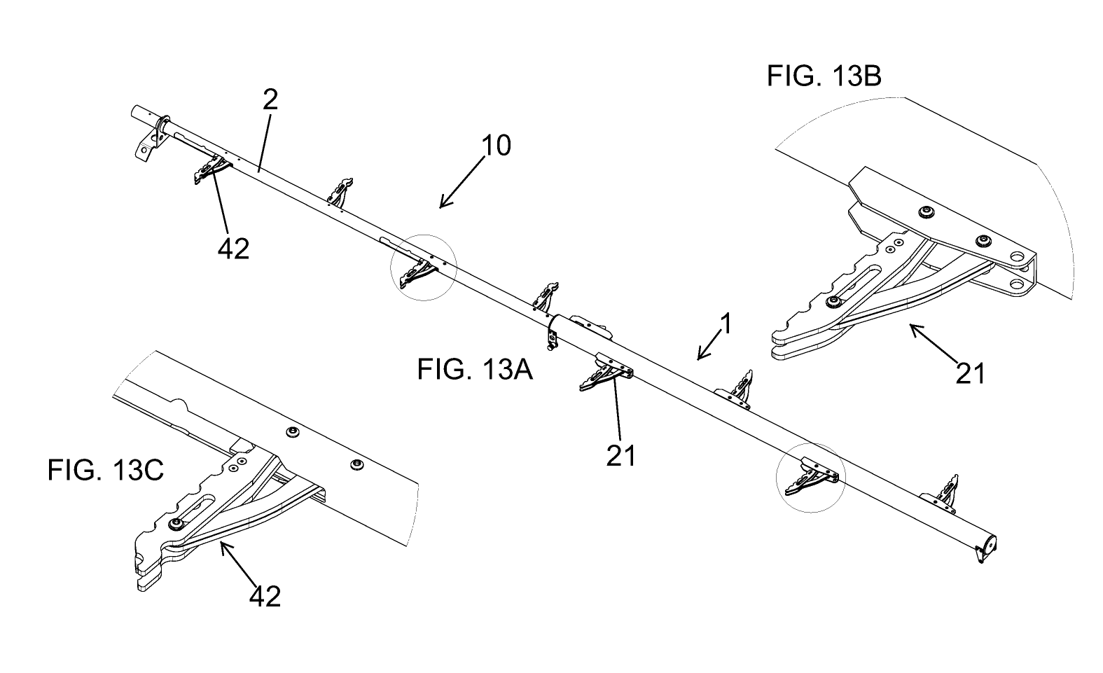

Referring now to FIGS. 1 through 13, the telescoping ladder 10 of the present invention includes an outer main body 1, at least one sliding body 2, a carrying strap 4 and a harness 3 for mounting to trees or other structures. The telescoping ladder 10 of the present invention may have a first main component in the outer main body 1. The sliding body 2 is contained within the outer main body 1. In certain embodiments, the attachment harness 3 and the carrying strap 4 may be attached to the outer main body 1.

As illustrated in FIG. 1, the outer main body 1 is a larger tubular component with the sliding body 2 smaller tubular component inside and sharing the same axis. The sliding body 2 may be secured in a retracted position wherein the sliding body 2 is within the outer main body 1 and an extended position wherein the sliding body 2 is outside of the outer main body 1. In certain embodiments, the sliding body 2 may be prevented from separating from the main body 1 by a stopper. In certain embodiments, the sliding body 2 is prevented from rotating around the axis within the main body 1 by a locking mechanism 29. On the exterior of the outer main body 1 are securely fastened multiple folding foot assemblies 21. The foot assemblies 21 may be in a closed position for travel and may be held in the closed position by magnets 33 or latches. Also securely fastened onto the exterior of the main body 1 is the locking assembly 28. The locking assembly 28 may interact with the sliding body 2 and hold the sliding body 2 in an extended or retracted position.

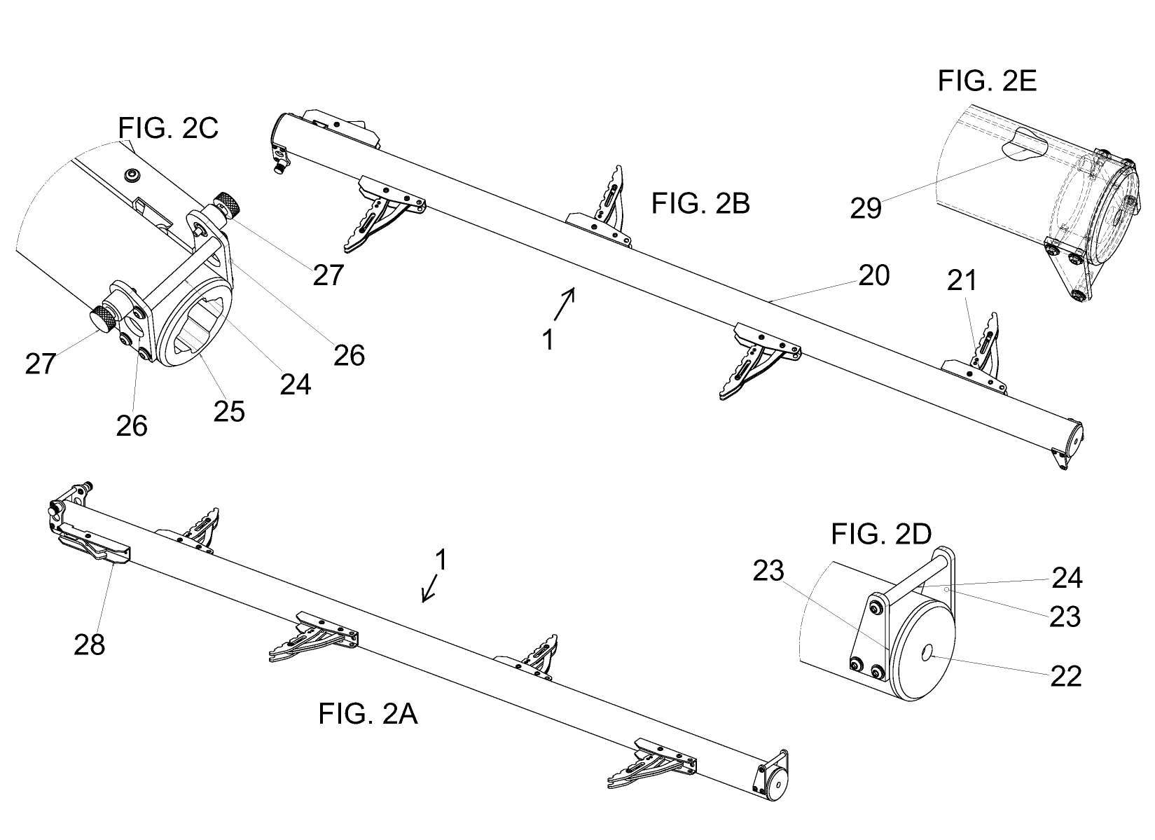

As illustrated in FIG. 2A through 2D, the outer body 1 includes a hollow tube 20, with multiple foot assemblies 21, a base cap 22, a lower shaft support 23, and a lower shaft 24. The outer body 1 may further include an upper cap 25, an upper locking bracket 26, and a lock mechanism 27, which may include spring loaded pins. The outer body 1 may further include the locking body assembly 28 for holding the sliding member 2 in the extended or retracted position. The outer body 1 may further include a rotation lock 29 preventing the sliding member 2 from rotating relative to the outer body 1.

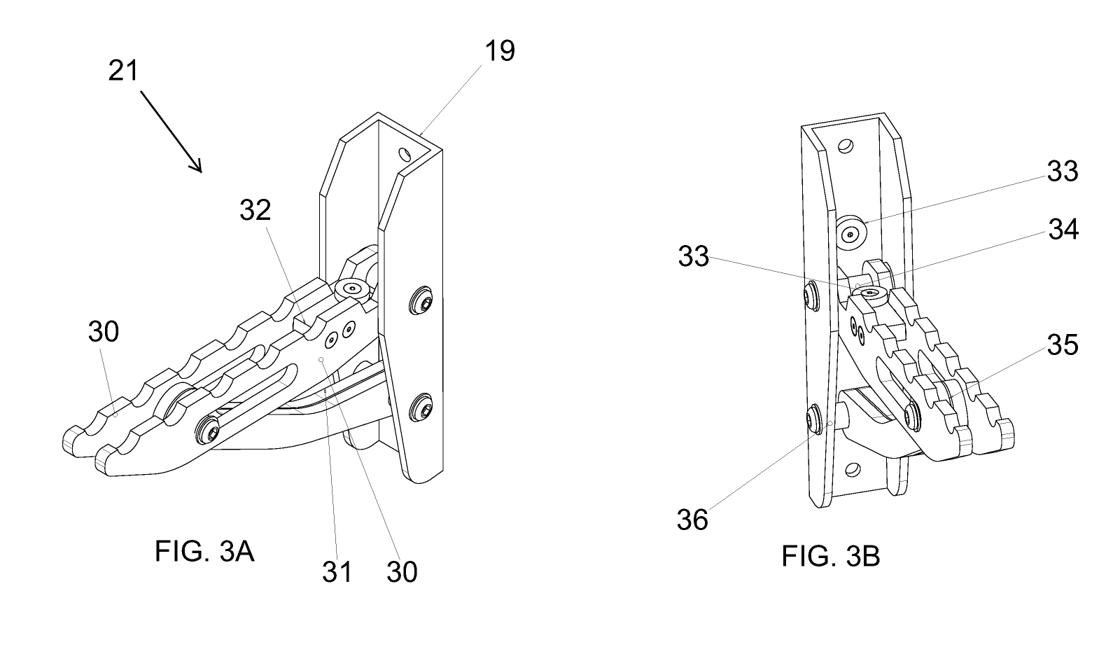

FIGS. 3A and 3B provide detail views of the foot assemblies 21 of the outer body 1. The foot assemblies 21 may include a main mount 19 attached to the outer body 1. The foot assemblies 21 may further include a foot 30 pivotally attached to the main mount 19 by a foot pivot 34. A foot support 31 may be pivotally attached to the main mount 19 underneath the foot 30 and connect with the foot 30 at a pivoting stop 35, which prevents the foot from further pivoting. To retain the foot 30 against the main mount 19 in a retracted position, the foot 30 may include a magnet block 32 and the main mount 19 may include a magnet 33.

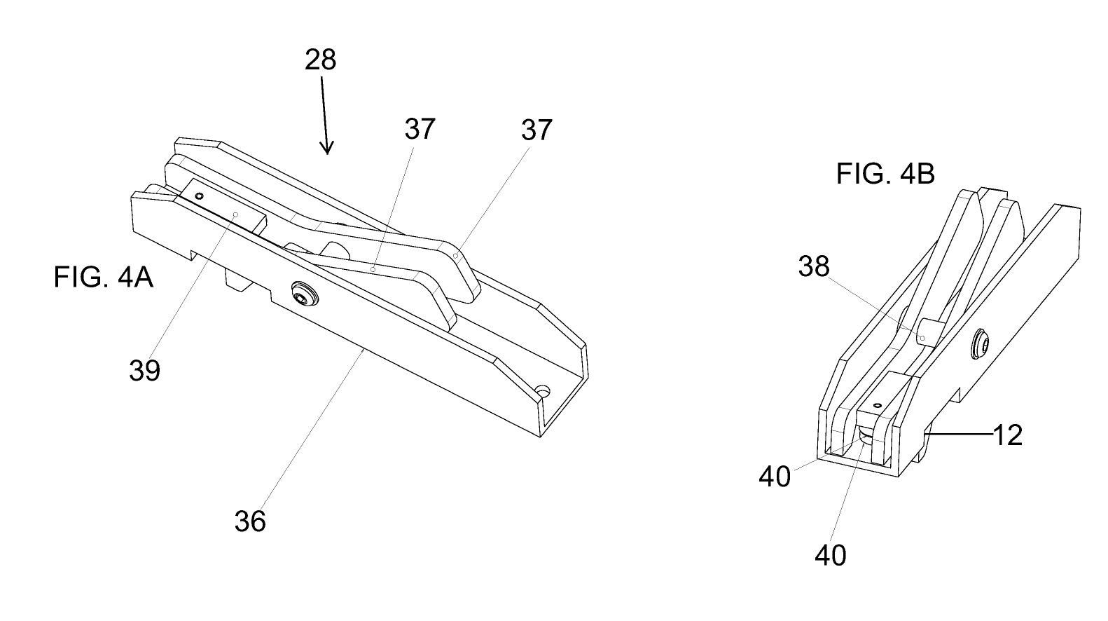

FIGS. 4A and 4B provide detail views of the lock body assembly 28. The lock body assembly 28 includes a main mount 36 attached to the main outer body 1. A lock lever 37 may be pivotally attached to the main mount 36 by a pivot 38. The lock lever 37 may include a first end and a second end, with the pivot 38 centrally disposed in between the first end and the second end. The first end may include a lock 12 protruding through the mount 36 and through the main outer body 1. The lock 12 may protrude into a mating portion of the sliding body 2 to retain the sliding body 2 in a locked position relative to the main outer body 1. The lock 12 may be biased in the locked position. In such embodiments, the first end may include a magnetic block 39 and the main mount 36 may include a magnet 40 attracting the magnetic block 39. To unlock the lock body assembly 28, the user may press down on the second end, removing the lock 12 from the mating portion of the sliding body 2.

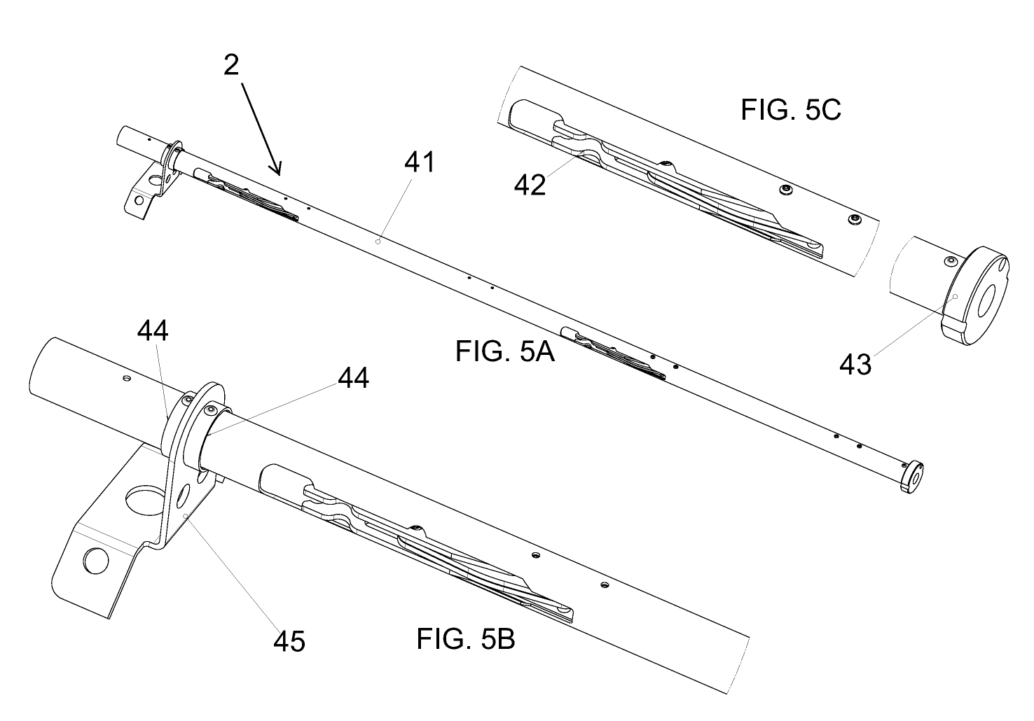

Referring to FIGS. 5A through 5C, the sliding body 2 may include a tube 41, which may be hollow. Foldable foot assemblies 42 may be attached to the tube 41. The sliding body 2 may include a stop 43 on the lower end, preventing the sliding body 2 from completely detaching from the main outer body 1. The sliding body 2 may further include a collar 44 preventing the sliding body 2 from being fully within the main outer body 1. The sliding body 2 may further include a strap bracket 45, which may protrude from the collar 44. The strap bracket 45 may be used to further secure the sliding body 2 to a tree or other surface.

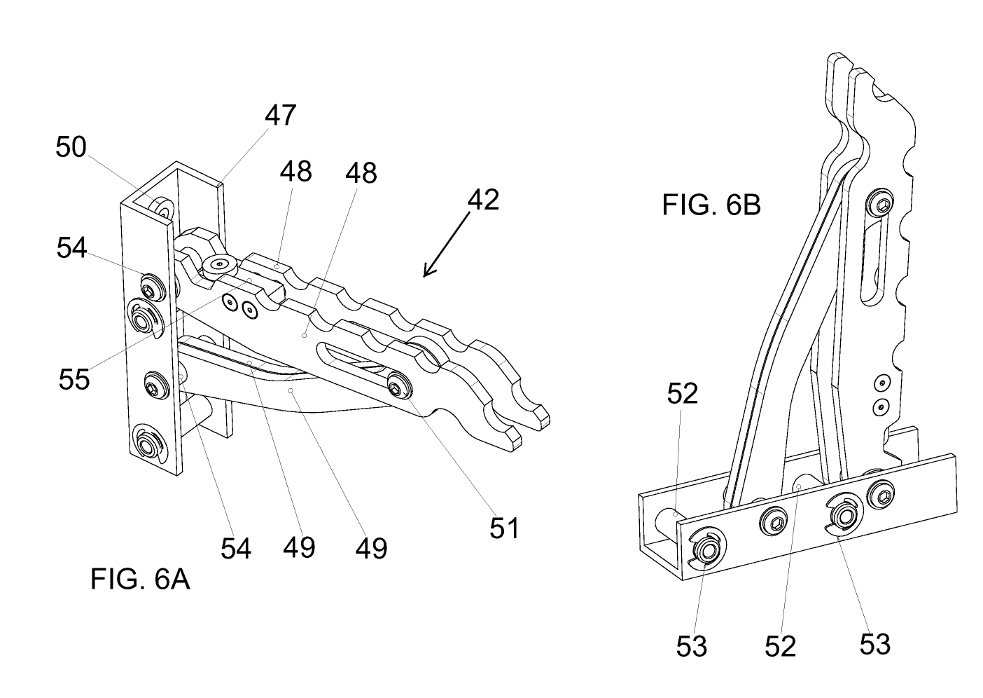

FIGS. 6A and 6B provide detail views of the foot assemblies 42 of the sliding body 2. The foot assemblies 42 may include a main mount 47 that may be attached within the sliding body 2 by a mounting shaft 52 and a retaining ring 53. The foot assemblies 42 may further include a foot 48 pivotally attached to the main mount 47 by a foot pivot 54. A foot support 49 may be pivotally attached to the main mount 47 underneath the foot 48 and connect with the foot 48 at a pivoting stop 51, which prevents the foot from further pivoting. To retain the foot 48 against the main mount 47 in a retracted position, the foot 48 may include a magnet block 55 and the main mount 47 may include a magnet 50.

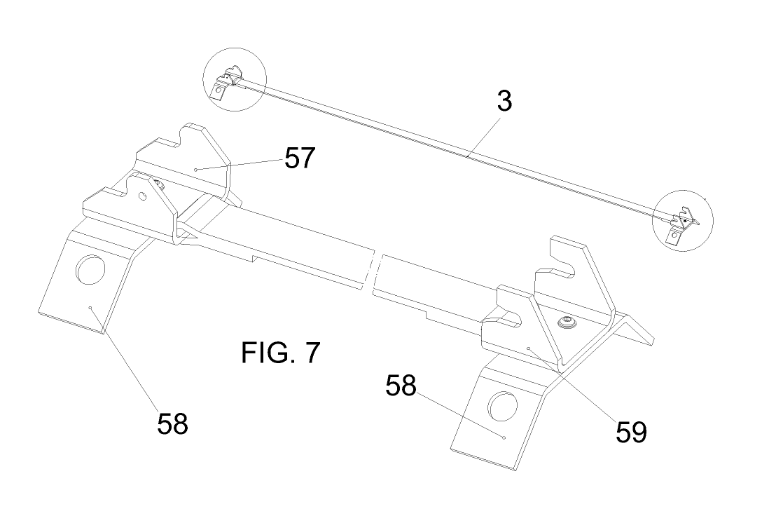

Referring to FIG. 7, the present invention may include an attachment harness 3. The attachment harness 3 may include a top end and a bottom end. The top end may be attached to an upper mounting bracket 57 and the bottom end may be attached to a lower mounting bracket 59. The upper mounting bracket 57 may be removably attached to an upper end of the main outer body 1 by the locking mechanism 27. The lower mounting bracket 59 may be pivotally attached to the lower shaft bracket 23 by the shaft 24.

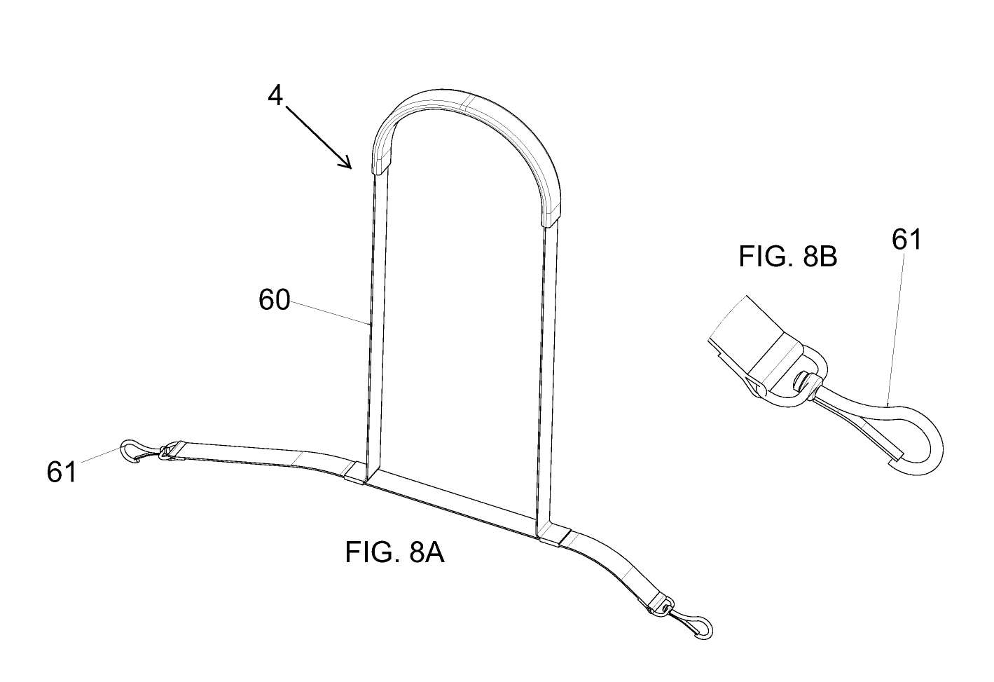

Referring to FIG. 8A and 8B, the present invention may include a carrying strap 4. The carrying strap 4 may include a main strap 60 and two spring snaps 61 attached to opposing ends of the main strap 60. The two spring snaps 61 may secure to the outer main body 1. The main strap 60 may include a protruding loop for a user to easily carry the outer main body 1 by placing the protruding loop over the user's shoulder.

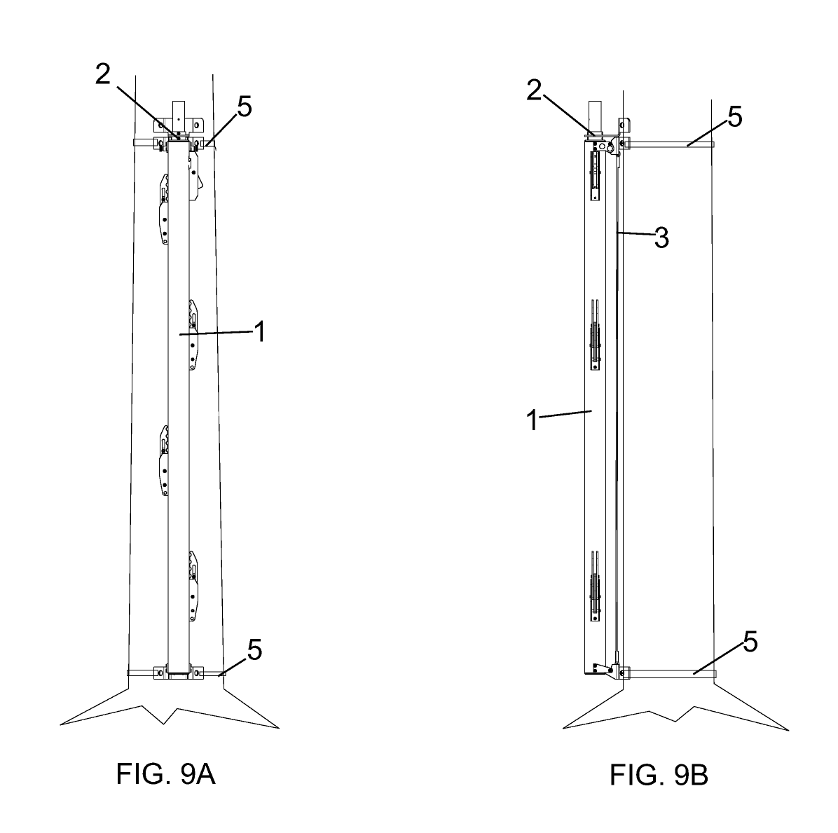

The telescoping ladder 10 of the present invention is a collapsible telescoping assembly with a carrying strap 4 that is man portable to a site for a need to acquire a height advantage for a variety of reasons. The present invention may be used as a used sports climber for hunters, photographers, observers, and the like. Once a site is found, the telescoping ladder 10 is placed up against the object such as a tree or other object and the telescoping ladder is secured to the object with ratcheting straps 5. The attachment may be done at two locations on each strap bracket 58, 59, as illustrated in FIG. 9. The telescoping ladder 10 may now be considered secured and ready for use.

In certain embodiments, the telescoping ladder 10 may be removed and transported separate from the main mounting harness 3 for safe storage or another location for use (with the use of a second mounting harness 3.) Alternatively, the telescoping ladder 10 may be extended its maximum height for use as a ladder.

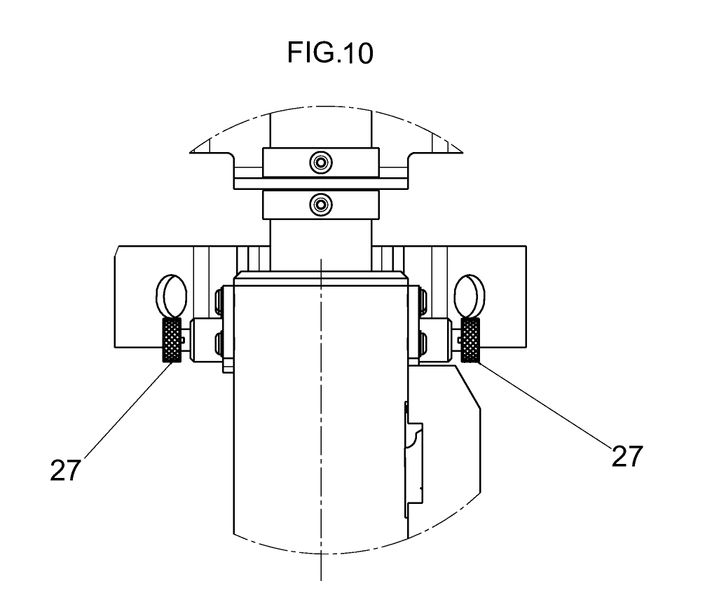

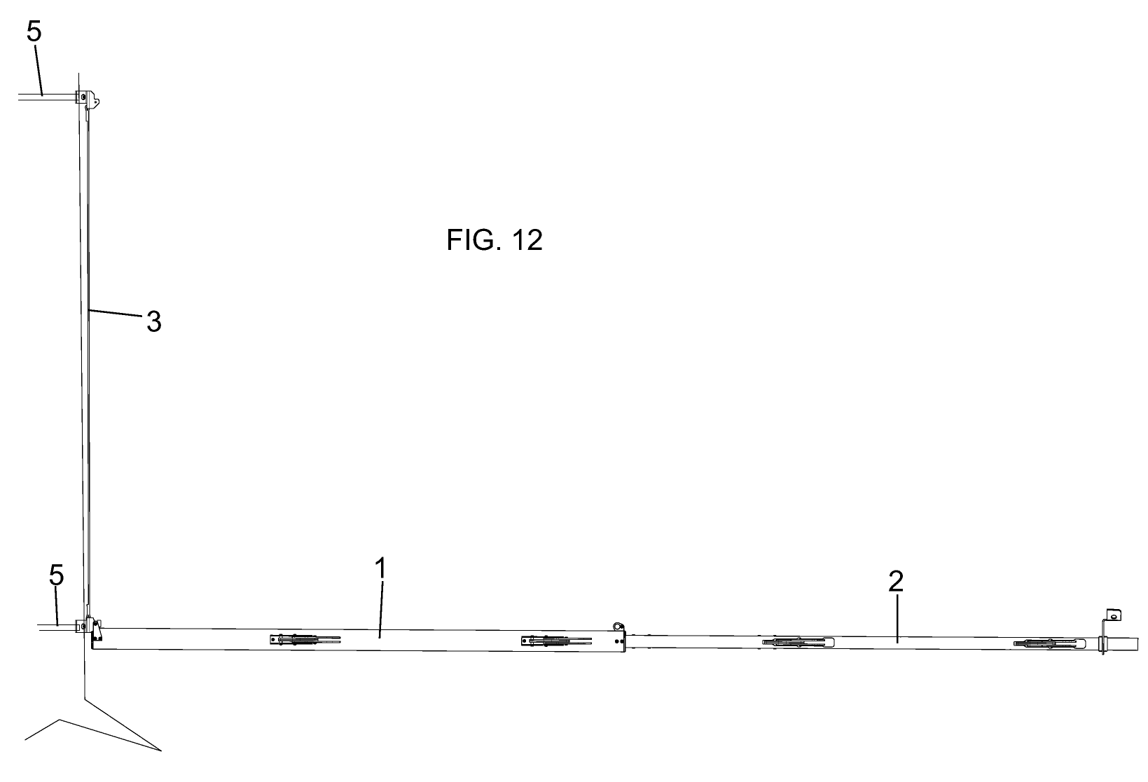

During the removal of the telescoping ladder 10, the locking mechanism 27 may be unlocked by pulling the two spring plungers of the locking mechanism 27 outward, as illustrated in FIG. 10. The telescoping ladder 10 may be rotated and pivoted at the bottom shaft 24. The telescoping ladder 10 may be lifted out of the slots on the lower mounting bracket 59 as illustrated in FIG. 12. The telescoping ladder 10 may now be free to transport separate from the mounting harness 3.

To extend the present invention to use as a ladder, the following may take place. The two spring plungers of the locking mechanism 27 may be pulled outward and locked in an open position. The telescoping ladder 10 may be rotated and pivoted at the bottom shaft 24. The telescoping ladder 10 may be pivoted on the bottom shaft 24 until the unit touches the ground, approximately horizontal depending on terrain or obstacles. Then pull the sliding body 2 out to its maximum position. At this point any seat or other device can be mounted on the end of the sliding body 2. All folding foot assemblies 21, 42 can be opened at this point. The telescoping ladder 10 may be pivoted back now fully extended and in a position to climb.

At this point the present invention may be considered ready to be used to its full height. For the operator to ascend, the user may first open each of the folded foot assemblies 21, 42 on both the outer main body 1 and the sliding body 2 if this was not done in the previous action. The step assemblies 21, 42 may be a three point folding mechanisms meant to support the weight of the operator. The step assemblies in the sliding body 2 when closed allow the sliding body 2 to telescope into the main body 1. Once the operator has climbed to the top of the sliding member 2, another ratcheting strap 5 may be attached to the strap bracket 45 to further secure the telescoping ladder 10 to the tree. This ensures that any seat or other device mounted to the top of the telescoping ladder 10 is fully secure as close to the top as possible.

The climbing device of the present invention can be made in various sizes. In some embodiments, the main body (outer body) of the climbing device can be from about 4 feet to about 8 feet, typically about 6 feet, in length. Further, the present invention may include additional sliding bodies, such as a second sliding body within the first sliding body 2.

An anti-rotation lock 29 can be included as a feature to prevent all moving sections from rotating to complicate locking of the sections during raising and lowering. A foam pad can be included on the carrying strap which can disperse the pressure at the carrying point on the shoulder of the operator when carrying the invention long distances.

It should be understood, of course, that the foregoing relates to exemplary embodiments of the invention and that modifications may be made without departing from the spirit and scope of the invention as set forth in the following claims.

What is claimed is:

1. A climbing device comprising:
an outer body;
a sliding body telescopically disposed in the outer body and extendable therefrom;
a plurality of foldable foot assemblies operable to pivot outwardly from the climbing device; and
a harness operable to attach to a structure, the harness operable to removably secure the outer body.

2. The climbing device of claim 1, further comprising a carrying strap disposed on the climbing device.

3. The climbing device of claim 1, wherein the outer body is from about 4 feet to about 8 feet in length.

4. The climbing device of claim 1, wherein the sliding body comprises the foldable foot assemblies, wherein the foldable foot assemblies pivot to permit the sliding body to telescope into and out of the main outer body.

5. The climbing device of claim 1, wherein the plurality of foldable foot assemblies are operable to pivot outwardly from each of the outer main body and sliding body.

6. The climbing device of claim 1, wherein the main outer body comprises a locking body assembly configured to lock the sliding body in a fixed position relative to the main outer body.

7. The climbing device of claim 6, wherein the locking body assembly comprises a locking lever pivotally attached to the main outer body and comprises a lock formed to protrude through the main outer body and into a mating portion of the sliding body in the locked position.

8. The climbing device of claim 7, wherein the lock is biased in a locked position by magnets.

9. The climbing device of claim 1, further comprising a plurality of ratcheting straps operable to connect to the harness and wrap around the support.

10. The climbing device of claim 9, wherein the support is a tree.

11. The climbing device of claim 9, wherein the harness includes an upper mounting bracket and a lower mounting bracket, wherein the upper and lower mounting brackets are operable to grip into the support.

12. The climbing device of claim 11, wherein the main body comprises lower shaft bracket and an upper locking bracket comprising a locking mechanism, wherein the lower shaft bracket is pivotally attached to the lower mounting bracket, and the upper locking bracket is releasably attachable to the upper mounting bracket by the locking mechanism.

13. The climbing device of claim 12, wherein the locking mechanism comprises at least one spring loaded pin, wherein the upper mounting bracket comprises at least one mating portion to receive the spring loaded pin.

14. A climbing device comprising:
an outer body;
a sliding body telescopically disposed in the outer body and extendable therefrom;
a locking body assembly configured to lock the sliding body in a fixed position relative to the main outer body;
a harness having upper and lower mounting brackets operable to attach to a structure, the harness operable to removably secure the outer body; and
a plurality of foldable foot assemblies operable to pivot outwardly from each of the outer body and the sliding body.

15. The climbing device of claim 14, further comprising a carrying strap disposed on the climbing device.

16. The climbing device of claim 14, wherein the upper and lower harness brackets are operable to grip into the support.
